(19) United States
(12) Patent Application Publication
(10) Pub. No.: US 2026/0361977 A1
(43) Pub. Date: Nov. 12, 2026

(54) GENERATING ANALYTICS BASED ON ENDPOINT DEVICE EVENTS

(71) Applicant: NETFLIX, INC., Los Gatos, CA (US)

(72) Inventors: Kinesh Ashwinkumar SATIYA, Redwood City, CA (US); Priyankaa VIJAYAKUMAR, San Carlos, CA (US); Simon Lloyd SPENCER, Sunnyvale, CA (US); Indrajit ROY CHOUDHURY, Dublin, CA (US)

(21) Appl. No.: 19/418,429

(22) Filed: Dec. 12, 2025

Related U.S. Application Data
(60) Provisional application No. 63/801,730, filed on May 7, 2025.

(51) Int. Cl. H04N 21/83; H04N 21/235; H04N 21/24

(52) U.S. Cl. CPC H04N 21/83; H04N 21/2353; H04N 21/2408

(57) ABSTRACT

In various embodiments, a computer-implemented method for processing playback event data includes identifying a content item for playback by an endpoint device, wherein the content item is associated with a campaign and an identifier, transmitting the content item to the endpoint device for playback, receiving playback event data associated with playback of the content item by the endpoint device, extracting the identifier from the playback event, retrieving metadata associated with the campaign from a metadata data store, enriching the playback event with the metadata, and generating an output data stream that includes the playback event data.

### CROSS-REFERENCE TO RELATED APPLICATIONS

This application claims priority to U.S. Provisional Application Number 63/801,730, filed May 7, 2025, the contents of which are incorporated by reference herein in its entirety.

### BACKGROUND

### Field of the Various Embodiments

Embodiments of the present disclosure relate generally to network-accessible services and, more specifically, to generating analytics based on endpoint device events.

### Description of the Related Art

Modern network-accessible services, such as streaming media services, are accessed by users using an endpoint device that executes a playback application. The playback application can include a browser that renders a playback user interface in which content from one or more content servers is rendered. As another example, a playback application can include a special purpose client running on the endpoint device that retrieves streaming media from one or more content servers and plays back the content on the endpoint device. In either scenario, playback events can occur on the endpoint device. Such playback events contain information that can be used to optimize performance of the streaming media service or include information that is useful for another purpose. For example, playback events relating to content provided to the endpoint device can be used as a basis for generating viewing analytics.

In some cases, under current approaches, when content is provided to an endpoint device, a unique token is provided to the endpoint device along with the content. Information about the content as well as the endpoint device, a user of the endpoint device, a campaign associated with the content, or other metadata, is stored in a data store associated with the streaming service along with the unique token. However, all the metadata is typically not provided to the endpoint device. The endpoint device can generate playback events related to playback of the content on the endpoint device. Information about such playback events, also referred to herein as playback event data, is then provided back to one or more servers associated with the streaming service along with the unique token. When the unique token is received along with the playback event data from the endpoint device, the metadata associated with the unique token is not included with the playback event data. If the playback event data is subsequently provided to downstream systems, the downstream systems receive the playback event data including the unique token but not the metadata that is stored in a data store maintained by the platform or service that generated the metadata. Accordingly, to retrieve metadata associated with the content, the endpoint device, the user, or the campaign, downstream consumers of playback event data must make a separate request to retrieve the metadata from the platform or service.

At least one technical drawback of the foregoing approach is that downstream systems that consume playback event data associated with the playback of content are required to retrieve such playback event data directly from the same platform or service that generates the corresponding unique token. Such a tightly coupled arrangement imposes a centralized dependency that functions as both a single point of failure and a systemic bottleneck. As a result of such a dependency, a resulting data pipeline for providing playback event data can exhibit increased operational latency and reduced throughput, particularly as request volume scales. Such characteristics of the resulting data pipeline further impede the ability of downstream systems to obtain the playback event data, thereby rendering timely observation or monitoring of such even data difficult or impossible.

As the foregoing illustrates, what is needed in the art are improved techniques for obtaining playback event data from an endpoint device and distributing the playback event data to downstream consumers.

### SUMMARY

One embodiment sets forth a computer-implemented method for processing playback event data that includes identifying a content item for playback by an endpoint device, wherein the content item is associated with a campaign and an identifier, transmitting the content item to the endpoint device for playback, receiving playback event data associated with playback of the content item by the endpoint device, extracting the identifier from the playback event, retrieving metadata associated with the campaign from a metadata data store, enriching the playback event with the metadata, and generating an output data stream that includes the playback event data.

At least one technical advantage of the disclosed techniques relative to the prior art is that the disclosed techniques enable a streaming service to obtain and distribute playback event data relating to playback of content in real time. In particular, the disclosed techniques provide a mechanism for reliably identifying sessions corresponding to playback of content based on playback event data received from an endpoint device. The identified sessions are output as a data stream in real time, thereby reducing or eliminating latency between when playback of the content occurs and when information about the session is made available to downstream consumers. By decoupling the ingestion of playback event data from subsequent session identification and distribution, the disclosed techniques further enable improved scalability, fault isolation, and throughput in environments where large volumes of playback events are generated. Such an approach can substantially improve overall system performance and reduce latency associated with tracking playback events in a streaming media service, particularly in streaming media services that serve large or highly concurrent user bases.

These technical advantages provide one or more technological advancements over prior art approaches.

### BRIEF DESCRIPTION OF THE DRAWINGS

So that the manner in which the above recited features of the various embodiments can be understood in detail, a more particular description of the inventive concepts, briefly summarized above, may be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 illustrates a network infrastructure used to distribute content to content servers and endpoint devices, according to various embodiments;

FIG. 2 is a more detailed block diagram of the content server of FIG. 1, according to various embodiments;

FIG. 3 is a more detailed block diagram of the control server of FIG. 1, according to various embodiments;

FIG. 4 is a more detailed block diagram of the endpoint device of FIG. 1, according to various embodiments;

FIG. 5 illustrates an events pipeline showing how playback events are processed by event publisher application;

FIG. 6 is a flow diagram of method steps for generating enriched playback event data by the event publisher application; and

FIG. 7 is a flow diagram of method steps for generating session data from enriched playback event data published by the event publisher application.

### DETAILED DESCRIPTION

In the following description, numerous specific details are set forth to provide a more thorough understanding of the various embodiments. However, it will be apparent to one skilled in the art that the inventive concepts may be practiced without one or more of these specific details.

Various technical issues emerge when distributing content to endpoint devices from a streaming media service for a large population of users. In particular, the operator of the streaming media service as well as other stakeholders rely upon increasingly large amounts of data regarding playback of content provided to users. For example, when content is provided to an endpoint device for playback, the process of selecting the content is associated with a large amount of metadata. In the case of an auxiliary content item that is associated with primary media content being provided to an endpoint device, information about a campaign is typically associated with selection of the content. For example, a campaign can specify demographic targeting information, frequency capping data associated with the campaign that specifies how often or how many times the content should be played by endpoint devices, playback minimums, playback maximums, and other metadata defining a campaign that is associated with distribution of the content to endpoint devices. Additionally, campaigns are also associated with evolving types of metadata and other information associated with the campaigns. For example, events relating to a user engaging with an interactive content item, scanning a displayed quick-response (QR) code, pausing a content item, or performing other interactions with content are events that an endpoint device or another device can report back to a streaming media service.

In a streaming media service, events associated with playback of content, such as auxiliary content, are reported to downstream consumer systems. Downstream consumer systems can be linked with entities external to a streaming media service and facilitate the implementation of campaigns. Accordingly, downstream consumer systems ingest events related to when a particular content item is shown to a user, whether a user views or interacts with the content item, playback of the content item, and other user interactions with the content item.

Prior solutions to reporting playback event data to downstream systems involved an event reporting system that reports information about a particular playback event along with an opaque token. Downstream systems would then request information about the playback event from the event reporting system, where the request would include the opaque token. The token is opaque in the sense that a downstream system could not determine any information about a campaign, content item, endpoint device, or any other metadata linked to the token without making a request to the event reporting system. In this framework, a large amount of computing load is placed on the event reporting system to handle one or more requests from one or more downstream systems, potentially regarding the same playback event.

To address the foregoing issues, embodiments of the disclosure provide a playback event publisher receives playback event data from an endpoint device. The playback event data corresponds to playback of a content item, such as an auxiliary content item, on the endpoint device. The playback event data includes an identifier that is associated with a campaign linked the content provided to the endpoint device. When a playback event data is received from the endpoint device, the playback event publisher identifies the campaign associated with the content item.

The playback event publisher identifies metadata associated with the campaign based on the identifier and generates enriched playback event data based on the playback event data received from the endpoint device and the metadata. The enriched playback event data is then published to an output data stream that is provided to downstream data consumers. The playback event publisher also stores the enriched playback event data into a data store so that downstream data consumers can access the metadata associated with the campaign as well as the playback event data from the output data stream or from the data store.

Additionally, an event sessionizer identifies sessions based on the enriched playback event data and saves session data associated with the enriched playback event data in a session data store. By generating coherent sessions from multiple playback events, downstream data consumers can generate analytics based on the sessions generated by the event sessionizer.

At least one technical advantage of the disclosed techniques relative to the prior art is that the disclosed techniques enable a streaming service to obtain and distribute playback event data relating to playback of content in real time. In particular, the disclosed techniques provide a mechanism for reliably identifying sessions corresponding to playback of content based on playback event data received from an endpoint device. The identified sessions are output as a data stream in real time, thereby reducing or eliminating latency between when playback of the content occurs and when information about the session is made available to downstream consumers. By decoupling the ingestion of playback event data from subsequent session identification and distribution, the disclosed techniques further enable improved scalability, fault isolation, and throughput in environments where large volumes of playback events are generated. Such an approach can substantially improve overall system performance and reduce latency associated with tracking playback events in a streaming media service, particularly in streaming media services that serve large or highly concurrent user bases.

These technical advantages provide one or more technological advancements over prior art approaches.

### System Overview

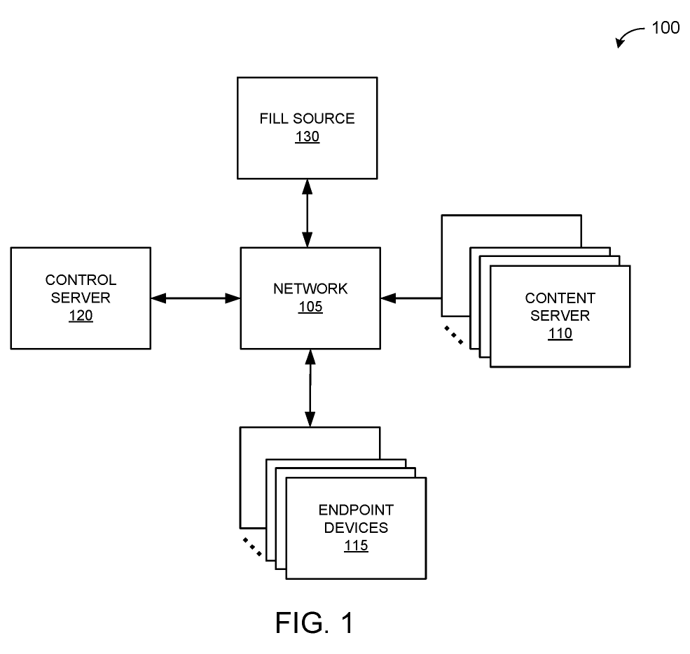

FIG. 1 illustrates a network infrastructure 100 that can be used by a network-accessible service such as a streaming media service to distribute content to content servers 110 and endpoint devices 115, according to various embodiments. As shown, the network infrastructure 100 includes content servers 110, a control server 120, and endpoint devices 115, each of which is connected via a communications network 105.

Each endpoint device 115 communicates with one or more content servers 110 (also referred to as “caches” or “nodes”) via the network 105 to download content, such as textual data, graphical data, audio data, video data, and other types of data. The downloadable content, also referred to herein as a “file,” is then presented to a user of one or more endpoint devices 115. In various embodiments, the endpoint devices 115 may include computer systems, set top boxes, mobile computers, smartphones, tablets, console and handheld video game systems, digital video recorders (DVRs), DVD players, connected digital TVs, dedicated media streaming devices (e.g., the Roku® set-top box), and/or any other technically feasible computing platform that has network connectivity and is capable of presenting content, such as text, images, video, and/or audio content, to a user.

Each content server 110 may include a webserver, a database, and a server application configured to communicate with the control server 120 to determine the location and availability of various files that are tracked and managed by the control server 120. Each content server 110 may further communicate with a fill source 130 and one or more other content servers 110 in order to “fill” each content server 110 with copies of various files. In addition, content servers 110 may respond to requests for files received from endpoint devices 115. The files may then be distributed from the content server 110 or via a broader content distribution network. In some embodiments, the content servers 110 enable users to authenticate (e.g., using a username and password) in order to access files stored on the content servers 110. Although only a single control server 120 is shown in FIG. 1, in various embodiments multiple control servers 120 may be implemented to track and manage files.

In various embodiments, the fill source 130 may include an online storage service (e.g., Amazon® Simple Storage Service, Google® Cloud Storage, etc.) in which a catalog of files, including thousands or millions of files, is stored and accessed in order to fill the content servers 110. Although only a single fill source 130 is shown in FIG. 1, in various embodiments multiple fill sources 130 may be implemented to service requests for files. Further, as is well understood, any cloud-based services can be included in the architecture of FIG. 1 beyond the fill source 130 to the extent desired or necessary.

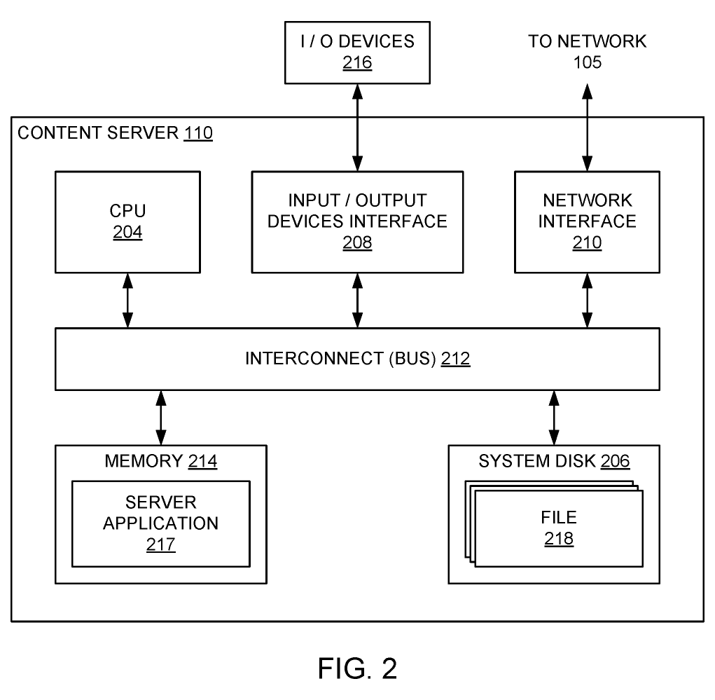

FIG. 2 is a block diagram of a content server 110 that may be implemented in conjunction with the network infrastructure 100 of FIG. 1, according to various embodiments. As shown, the content server 110 includes, without limitation, a central processing unit (CPU) 204, a mass storage 206, an input/output (I/O) devices interface 208, a network interface 210, an interconnect 212, and a system memory 214.

The CPU 204 is configured to retrieve and execute programming instructions, such as a server application 217, stored in the system memory 214. Similarly, the CPU 204 is configured to store application data (e.g., software libraries) and retrieve application data from the system memory 214. The interconnect 212 is configured to facilitate transmission of data, such as programming instructions and application data, between the CPU 204, the mass storage 206, the I/O devices interface 208, the network interface 210, and the system memory 214. The I/O devices interface 208 is configured to receive input data from I/O devices 216 and transmit the input data to the CPU 204 via the interconnect 212. For example, the I/O devices 216 may include one or more buttons, a keyboard, a mouse, and/or other input devices. The I/O devices interface 208 is further configured to receive output data from the CPU 204 via the interconnect 212 and transmit the output data to the I/O devices 216.

The mass storage 206 may include one or more hard disk drives, solid state storage devices, or similar storage devices. The mass storage 206 is configured to store non-volatile data such as files 218 (e.g., audio files, video files, subtitles, application files, software libraries, etc.). The files 218 can then be retrieved by one or more endpoint devices 115 via the network 105. In some embodiments, the network interface 210 is configured to operate in compliance with the Ethernet standard.

The system memory 214 includes the server application 217 configured to service requests for the files 218 received from an endpoint device 115 and other content servers 110. When the server application 217 receives a request for a file 218, the server application 217 retrieves the corresponding file 218 from the mass storage 206 and transmits the file 218 to an endpoint device 115 or a content server 110 via the network 105.

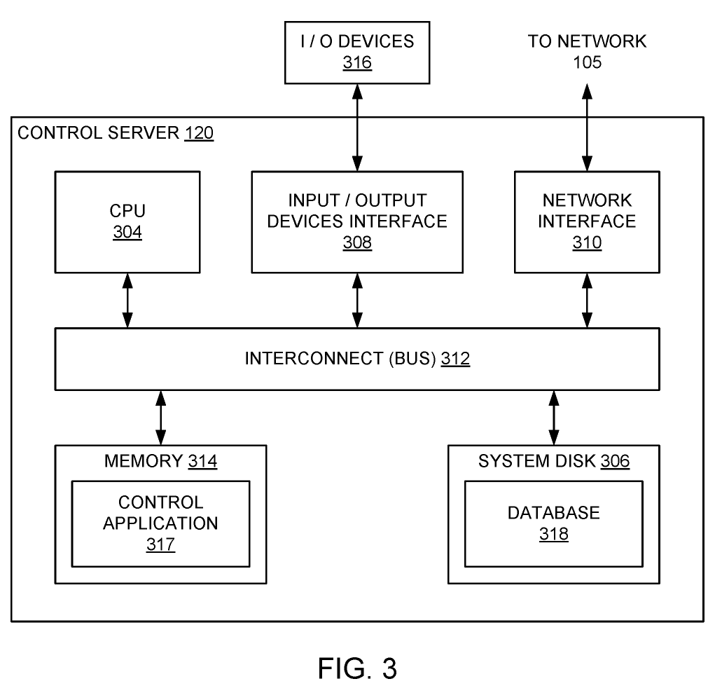

FIG. 3 is a block diagram of a control server 120 that may be implemented in conjunction with the network infrastructure 100 of FIG. 1, according to various embodiments. As shown, the control server 120 includes, without limitation, a central processing unit (CPU) 304, a mass storage 306, an input/output (I/O) devices interface 308, a network interface 310, an interconnect 312, and a system memory 314.

The CPU 304 is configured to retrieve and execute programming instructions, such as a control application, a playback event publisher 317, and an event sessionizer 320, stored in the system memory 314. Similarly, the CPU 304 is configured to store application data (e.g., software libraries) and retrieve application data from the system memory 314 and a database 318 stored in the mass storage 306. The interconnect 312 is configured to facilitate transmission of data between the CPU 304, the mass storage 306, the I/O devices interface 308, the network interface 310, and the system memory 314. The I/O devices interface 308 is configured to transmit input data and output data between I/O devices 316 and the CPU 304 via the interconnect 312. The mass storage 306 may include one or more hard disk drives, solid-state storage devices, and the like. The mass storage 306 is configured to store a database 318 of information associated with the content servers 110, the fill source(s) 130, and the files 218.

The system memory 314 can include a control application configured to access information stored in the database 318 and process the information to determine the manner in which specific files 218 will be replicated across content servers 110 included in the network infrastructure 100. The control application may further be configured to receive and analyze performance characteristics associated with one or more of the content servers 110 and/or endpoint devices 115.

The system memory 314 further includes an event publisher application 317. The event publisher application 317 receives playback event data from one or more endpoint devices 115 and stores the playback event data in a data store. The event publisher application 317 also enriches the playback event data with metadata associated with the endpoint device 115, a content item associated with the playback event, a campaign associated with the content item, or other metadata accessible to the event publisher application 317 with which a playback event can be enriched. The event publisher application 317 further publishes the enriched playback event into an output data stream for downstream consumer systems. The event publisher application 317 also stores the enriched playback event into a data store that other systems, such as downstream consumer systems, can access to retrieve enriched playback event data.

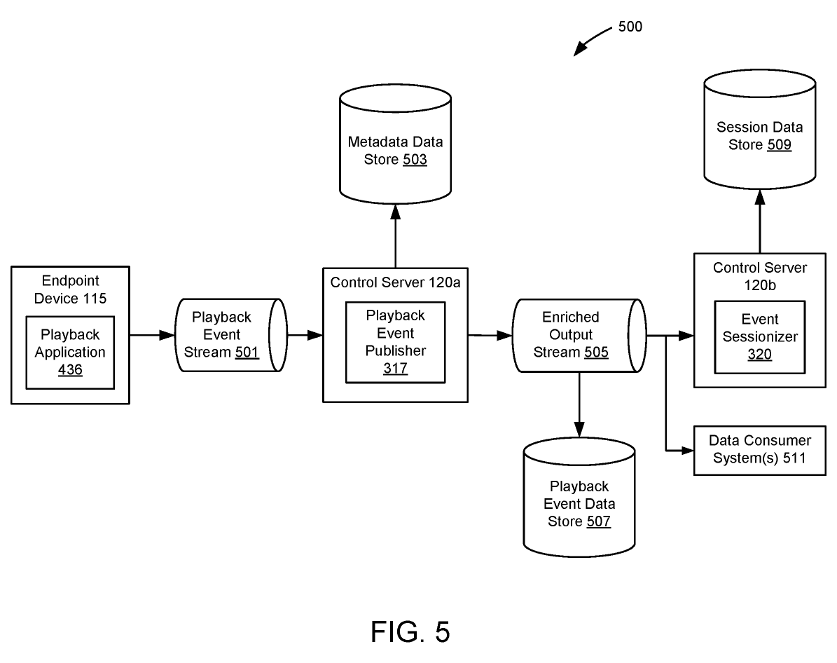

The system memory 314 further includes an event sessionizer 320. The event sessionizer 320 retrieves playback event data published by the event publisher application 317 into the output data stream and assembles data associated with multiple playback events into a single and coherent session. The event sessionizer 320 stores the session data into a data store that can be accessed by downstream consumer systems. Additional detail regarding the event publisher application 317 and/or the event sessionizer 320 is provided in connection with the discussion of FIGS. 5-7.

Referring generally to FIGS. 1-3, in various embodiments, the network infrastructure 100 is configured to implement an encoding pipeline (also referred to as an “encoder”) to compress audiovisual content associated with media titles prior to streaming to endpoint device(s) 115. For example, and without limitation, the control server 120 of FIGS. 1 and 3 could implement an encoding pipeline that compresses files 218 prior to transmission to an endpoint device 115. Alternatively, and without limitation, files stored in the fill source 130 could be compressed, via an encoding pipeline within the network infrastructure 100, prior to storage.

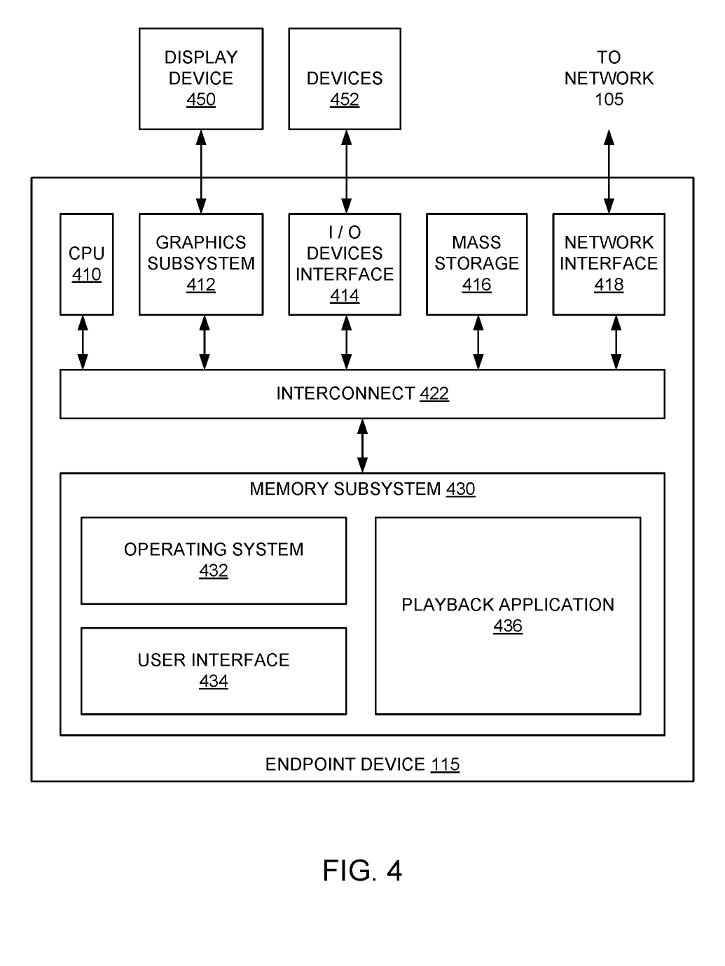

FIG. 4 is a block diagram of an endpoint device 115 that may be implemented in conjunction with the network infrastructure 100 of FIG. 1, according to various embodiments of the present invention. As shown, endpoint device 115 may include, without limitation, a CPU 410, a graphics subsystem 412, an I/O device interface 414, a mass storage 416, a network interface 418, an interconnect 422, and a memory subsystem 430.

In some embodiments, the CPU 410 is configured to retrieve and execute programming instructions stored in the memory subsystem 430. Similarly, the CPU 410 is configured to store and retrieve application data (e.g., software libraries) residing in the memory subsystem 430. The interconnect 422 is configured to facilitate transmission of data, such as programming instructions and application data, between the CPU 410, graphics subsystem 412, I/O devices interface 414, mass storage 416, network interface 418, and memory subsystem 430.

In some embodiments, the graphics subsystem 412 is configured to generate frames of video data and transmit the frames of video data to display device 450. In some embodiments, the graphics subsystem 412 may be integrated into an integrated circuit, along with the CPU 410. The display device 450 may comprise any technically feasible means for generating an image for display. For example, the display device 450 may be fabricated using liquid crystal display (LCD) technology, cathode-ray technology, and light-emitting diode (LED) display technology. An input/output (I/O) device interface 414 is configured to receive input data from user I/O devices 452 and transmit the input data to the CPU 410 via the interconnect 422. For example, user I/O devices 452 may comprise one or more buttons, a keyboard, and a mouse or other pointing device. The I/O device interface 414 also includes an audio output unit configured to generate an electrical audio output signal. User I/O devices 452 include a speaker configured to generate an acoustic output in response to the electrical audio output signal. In alternative embodiments, the display device 450 may include the speaker. A television is an example of a device known in the art that can display video frames and generate an acoustic output.

A mass storage 416, such as a hard disk drive or flash memory storage drive, is configured to store non-volatile data. A network interface 418 is configured to transmit and receive packets of data via the network 105. In some embodiments, the network interface 418 is configured to communicate using the well-known Ethernet standard. The network interface 418 is coupled to the CPU 410 via the interconnect 422. The network interface 418 supports connections using different network protocols, such as IPv4, IPv6, and other IP-based protocols.

In some embodiments, the memory subsystem 430 includes programming instructions and application data that comprise an operating system 432, a user interface 434, and a playback application 436. The operating system 432 performs system management functions such as managing hardware devices including the network interface 418, mass storage 416, I/O device interface 414, and graphics subsystem 412. The operating system 432 also provides process and memory management models for the user interface 434 and the playback application 436. The user interface 434, such as a window and object metaphor, provides a mechanism for user interaction with endpoint device 115. Persons skilled in the art will recognize the various operating systems and user interfaces that are well-known in the art and suitable for incorporation into endpoint device 115.

In some embodiments, the playback application 436 is configured to request and receive content from the content server 110 via the network interface 418. Further, the playback application 436 is configured to interpret the content and present the content via display device 450 and/or user I/O devices 452. In one embodiment, the playback application 436 may include a decoding pipeline that decodes compressed content prior to display via the display device 450. In some embodiments, the playback application 436 is a browser executed by the endpoint device 115. For example, the browser can access one or more content pages via a network, such as the Internet, that are associated with a streaming media service. The streaming media service generates one or more content pages that include content such as images, text, videos, audio, and other content that is rendered on the endpoint device 115 by the browser.

The playback application 436 generates playback event data that correspond to user activity or activity with respect to content being played back on endpoint device 115. In one example, a system such as the control server 120 or an external system determines that a particular endpoint device 115 should be served a particular auxiliary content item associated with a campaign. Accordingly, the control server 120 identifies the campaign and the content item corresponding to the campaign. The content item can correspond to a media file on one or more content servers 110 that can be provided to the playback application 436 for playback. The control server 120 also generates a unique identifier associated with playback of the content item. The unique identifier can uniquely identify the occurrence of playback of the content item by the endpoint device 115. The unique identifier is stored in a database that stores information about content items distributed to endpoint devices 115. The unique identifier can also be provided to the playback application 436, which can in turn provide the unique identifier back to the event publisher application 317 whenever the content item is played back or whenever a user interaction with the content item occurs.

### Playback Events Pipeline

FIG. 5 illustrates an events pipeline 500 showing how playback event data is processed by event publisher application 317. FIG. 5 also illustrates how information associated with playback events are formed into sessions by event sessionizer 320, according to various embodiments. The events pipeline 500 includes an endpoint device 115 executing playback application 436, which reports playback event data into a playback event stream 501. The events pipeline 500 also includes control server 120a executing event publisher application 317, which receives playback event data published into the playback event stream 501 by endpoint device 115. The playback event data is published by endpoint devices 115 into playback event stream 501 as a key-value record. In one embodiment, a unique identifier associated with a content item provided to the endpoint device 115 is a key or a value associated with the record.

Event publisher application 317 enriches the playback event data with metadata from metadata data store 503, which houses information about the content item played back by the endpoint device 115 and that is associated with a unique identifier provided in a playback event from the endpoint device 115. The events pipeline 500 also includes an enriched output stream 505 that includes enriched playback event data generated by event publisher application 317. The events pipeline 500 also includes a playback event data store 507, where the enriched playback event data is stored for access by other systems. Events pipeline 500 also includes a control server 120 executing event sessionizer 320. The session data store 509 represents a data store into which session data generated by event sessionizer 320 is stored. Events pipeline 500 also includes, without limitation, a data consumer system 511. A data consumer system 511 represents any downstream system that ingests enriched events from enriched output stream 505 or from playback event data store 507.

For example, a data consumer system 511 can include a system that determines which content items, such as ads, should be served to an endpoint device 115 based on information about the campaign. A data consumer system 511 can also include a system that tracks impressions for a given campaign and any other frequency capping parameters based on enriched playback event data and that reports data about impressions for a given campaign to a system that determines which content items should be served to an endpoint device 115 based on the frequency capping data. A data consumer system 511 can also include a system that provides information about campaigns to external systems by retrieving enriched playback event data related to campaigns and providing information about playback of content to the external systems.

In the depicted events pipeline 500, an endpoint device 115 plays back a content item provided to playback application 436 by a content server 110. For example, the content item corresponds to an auxiliary content item that is played back during a live event or a streaming video on demand (SVOD) title being played back on the endpoint device 115. As noted above, along with the content item, a content server 110 can provide a unique identifier corresponding to the content item, such as an ad. The unique identifier can be generated by control server 120 and corresponds to a campaign associated with the content item. The unique identifier can uniquely identify the content item and the endpoint device 115 to which the content item is provided. In some examples, the unique identifier can also uniquely identify a transaction that comprises an occurrence of a content server 110 providing the content item to the endpoint device 115.

Within a streaming media service, a campaign is associated with a systematic effort to distribute content to various endpoint devices 115 based on one or more metrics, requirements, or other factors specified by the campaign. In one embodiment, a campaign is linked with a specific content item in the streaming media service. A campaign can be associated with delivery and reach metrics, which can include a quantity of impressions or the number of times an auxiliary content item is shown. A campaign can also be associated with a number of unique viewers or frequency metrics, which quantifies the average number of times a unique viewer is presented with a particular ad. In some embodiments, a campaign can be associated with a frequency cap, which caps the number of times a viewer is presented with an ad. Other metrics include a completion rate, or the percentage of viewers watching the auxiliary content item to completion, or quartile or other fractional completion rates, which quantify a percentage of viewers reaching a particular quartile or other fractional portion of an ad.

Other metrics associated with a campaign include a click-through rate, an engagement rate, time spent or average watch duration metrics, pause rates, and skip rates associated with an ad. A campaign can also be associated with audience and targeting metrics that determine which users or endpoint devices 115 receive an ad. For example, campaigns can be targeted at specific demographic categories, device types, or platform types. Campaigns can also be linked with conversion rates, attribution metrics, cost per click or cost per acquisition metrics, and other parameters or metrics. Accordingly, a content item provided to an endpoint device 115 can be associated with various attributes and parameters linked to an auxiliary content item or campaign.

Therefore, event publisher application 317 can associate playback event data received from an endpoint device 115 with one or more of the metadata attributes that are associated with a content item. The endpoint device 115 can report various types of playback events to the event publisher application 317 with respect to a content item that is an ad. For example, an endpoint device 115 can report when an auxiliary content item is started, which is also referred to as an impression event. The endpoint device 115 can report as separate events when playback has progressed through one or more of the quartiles of the auxiliary content item, when the auxiliary content item has completed playback, has been paused, resumed, or skipped, a click-through event, a rewind or seek event, or other types of events. Other devices can report events to the event publisher application 317, such as whenever a user scans a displayed QR code or follows a displayed link. The playback event data can include the unique identifier provided to the endpoint device 115 when the content item was provided to the endpoint device 115.

The playback event data generated by endpoint device 115 and reported back to the event publisher application 317 is published by the endpoint device 115 or a telemetry infrastructure into a playback event stream 501. The playback event stream 501 can include a continuous, unbounded flow of events or data records that are streamed to the event publisher application 317. In one embodiment, the playback event stream 501 is implemented using Apache Kafka Streams. On the playback event stream 501, the playback event data from the endpoint device 115 does not include metadata associated with the content item to which the events correspond. For example, the playback event data on the playback event stream 501 does not include information about a campaign from which downstream or feedback actions can be taken. In one scenario, a campaign might be associated with a frequency capping parameter. Therefore, to implement the frequency capping requirements of a campaign, the control server 120 or another server associated with a streaming media service must be able to determine when a particular auxiliary content item is played back on an endpoint device 115. When a frequency cap for a particular content item has been met or exceeded

Therefore, event publisher application 317 receives playback event data from playback event stream 501. For each playback event received, event publisher application 317 identifies a unique identifier associated with the playback event. As noted above, an identifier corresponding to the content item being played back by the endpoint device 115 is included as a part of the playback event generated by the endpoint device 115. Upon identifying the unique identifier associated with the playback event, event publisher application 317 retrieves metadata associated with the unique identifier that is stored in the metadata data store 503. In some embodiments, when the content item is provided to endpoint device 115 by an auxiliary content item server, control server 120, content server 110, or other system, information related to campaign parameters and other metadata is associated with the unique identifier within metadata data store 503. In other words, one or more systems or services identifying a content item such as an auxiliary content item or transmitting the content item to an endpoint device 115 populates the metadata data store 503 with information about a campaign or other metadata associated with the decision to provide the content item to the endpoint device 115. For example, if an endpoint device 115 is streaming a live event or an SVOD title, an auxiliary content item server can generate a decision to insert an auxiliary content item into the stream based on factors such as the identity of the content being streamed to the endpoint device 115, the identity of a user, a location of a user, the number of times the auxiliary content item has been played during a campaign to a population of users or to the specific user, and other factors. The factors upon which the decision is based can be saved as metadata in metadata data store 503.

After retrieving the metadata associated with the unique identifier from the metadata data store 503, the event publisher application 317 generates an enriched playback event data that includes the metadata usable by downstream systems. The enriched playback event data is generated according to a schema that defines a structured format for the enriched playback event data. The schema is stored by or accessible to the control server 120 and defines how enriched playback event data published into the enriched output stream 505 or stored in the playback event data store 507 is structured. In some embodiments, the schema is distributed to the data consumer systems 511 as well as the event sessionizer 320 so that downstream systems can determine how to extract whatever data is relevant to the downstream system based on the schema.

By storing the enriched playback event data in the playback event data store 507, the data consumer systems 511 or the event sessionizer 320 can retrieve, query, or otherwise access enriched playback event data asynchronously for analytics, reporting, or other purposes. Additionally, by publishing enriched playback event data into the enriched output stream 505, the data consumer systems 511 or the event sessionizer 320 can also receive enriched playback event data in real time.

The event sessionizer 320 receives enriched playback event data published by the event publisher application 317 into the enriched output stream 505. The event sessionizer 320 identifies enriched events that correspond to a session on an endpoint device 115. In some embodiments, a session corresponds to providing a specific content item, such as an auxiliary content item, to a specific endpoint device 115. The session also corresponds to the playback event data that are generated by the endpoint device 115 when the endpoint device 115 plays back the content item. For example, the session includes playback event data such as commencement of the auxiliary content item, quartile playback events, pause or seek events, playback completion events, or any other playback events associated with the content item that are referenced above.

Accordingly, the event sessionizer 320 identifies enriched events corresponding to a single session based on one or more identifiers or metadata embedded in the enriched events. For example, the event sessionizer 320 correlates enriched events together based on an auxiliary content item impression identifier, which can be the unique token, or one among many unique tokens, that are provided to the endpoint device 115 along with the content item. The endpoint device 115 can provide the unique token back to the event publisher application 317 when reporting a playback event on the playback event stream 501. Accordingly, event publisher application 317 can include the unique token in the enriched playback event data along with other metadata that the event sessionizer 320 can utilize to identify events that should be correlated together into a single session. Event sessionizer 320 can generate one or more data structures representing the session and store the session data in the session data store 509. The session can include information about all of the enriched playback event data associated with the session.

A data consumer system 511 is a downstream system that performs one or more operations on enriched playback event data from enriched output stream 505 or playback event data store 507. The event sessionizer 320 is an example of a type of data consumer system 511. Other examples include a system that tracks impressions for campaigns as well as frequency capping parameters that are created for a campaign. An auxiliary content item server can utilize such a system to ensure that ads are served within frequency capping limits that are specified for the campaign. Another example of a data consumer system 511 includes a system that calculates metrics based on the enriched playback event data from enriched output stream 505 or playback event data store 507. For example, real-time metrics can be calculated to assess delivery health of a campaign, apply budget capping functionality, calculate reach metrics, or determine any other performance or health related metrics associated with a campaign. As another example, a data consumer system 511 can also include a system that continuously or periodically sends information to third party systems, such as external systems, by extracting information from an enriched playback event structured according to the schema and reporting event data to the third-party system.

### Generating Enriched Playback Event Data

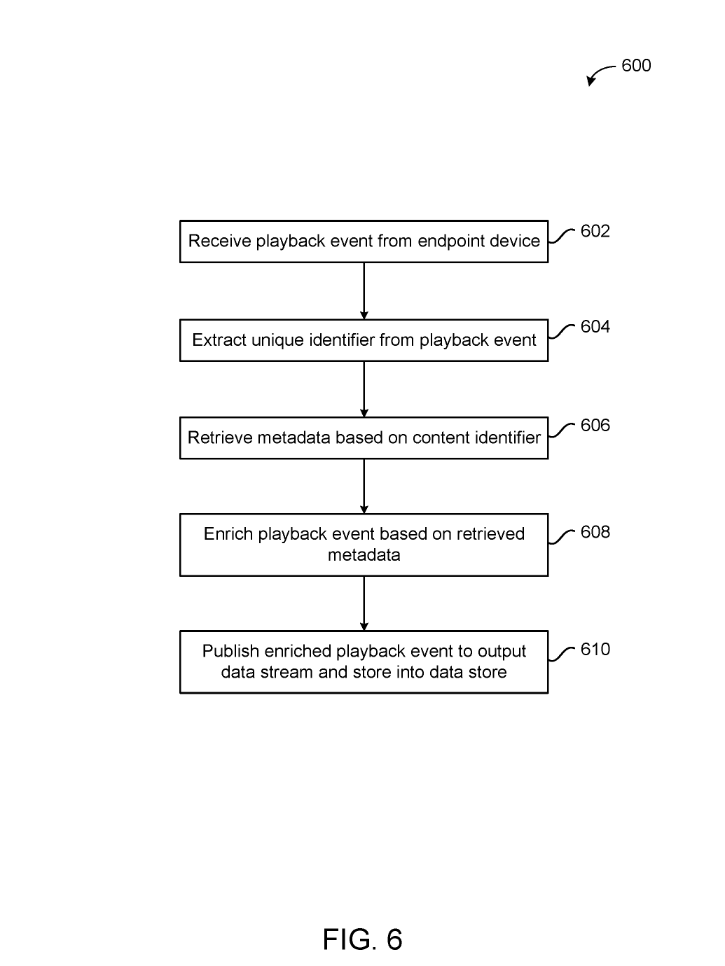

FIG. 6 is a flow diagram of method steps for generating enriched playback event data by the event publisher application 317. The enriched playback event data is generated in response to receiving playback event data from an endpoint device 115 on a playback event stream 501 within a streaming media service. Although the method steps are described in conjunction with the systems of FIGS. 1-5, persons skilled in the art will understand that any system configured to perform the method steps, in any order, is within the scope of the present invention.

As shown, a method 600 begins at step 602, where a control server 120, or the event publisher application 317 executed by the control server 120, receives a playback event from an endpoint device 115 that is published into a playback event stream 501. The event can correspond to an event that an endpoint device 115 reports to control server 120, such as a playback event associated with a streaming media title that is an ad. Examples of such events include pausing, stopping, completing, or seeking playback of a media title on the endpoint device 115. Other examples of events include network quality or playback quality telemetry events, or user interaction events such as interaction with user interface elements, recommendations, or other aspects of a user interface. The playback event data generated by endpoint device 115 and reported back to the event publisher application 317 is published by the endpoint device 115 or a telemetry infrastructure into a playback event stream 501. The playback event stream 501 can include a continuous, unbounded flow of events or data records that are streamed to the event publisher application 317. In one embodiment, the playback event stream 501 is implemented using Apache Kafka Streams. On the playback event stream 501, the playback event data from the endpoint device 115 does not include metadata associated with the content item to which the events correspond. For example, the playback event data on the playback event stream 501 does not include information about a campaign from which downstream or feedback actions can be taken. In one scenario, a campaign might be associated with a frequency capping parameter. Therefore, to implement the frequency capping requirements of a campaign, the control server 120 or another component associated with a streaming media service must be able to determine when a particular auxiliary content item is played back on an endpoint device 115.

At step 604, event publisher application 317 extracts a unique identifier from the playback event. The unique identifier comprises a token provided to the endpoint device 115 along with the content item. When the endpoint device 115 generates and reports playback events back to the event publisher application 317, the token or unique identifier is provided in the playback event that is generated by the endpoint device 115 and reported into the playback event stream 501.

At step 606, event publisher application 317 retrieves metadata from metadata data store 503 that is associated with the playback event. In some embodiments, when the content item is provided to endpoint device 115 by an auxiliary content item server, control server 120, content server 110, or other system, information related to campaign parameters and other metadata is associated with the unique identifier within metadata data store 503. In other words, one or more systems or services identifying a content item such as an auxiliary content item or transmitting the content item to an endpoint device 115 populates the metadata data store 503 with information about a campaign or other metadata associated with the decision to provide the content item to the endpoint device 115. For example, if an endpoint device 115 is streaming a live event or an SVOD title, an auxiliary content item server can generate a decision to insert an auxiliary content item into the stream based on factors such as the identity of the content being streamed to the endpoint device 115, the identity of a user, a location of a user, real-time information associated with real-time content, the number of times the auxiliary content item has been played during a campaign to a population of users or to the specific user, and other factors. Accordingly, event publisher application 317 retrieves the metadata associated with the unique identifier to enrich playback event data that is received from the endpoint device 115.

At step 608, after retrieving the metadata associated with the unique identifier from metadata data store 503, event publisher application 317 generates an enriched playback event that includes the metadata usable by downstream systems. The enriched playback event is generated according to a schema that defines a structured format for the enriched playback event. The schema is stored by or accessible to control server 120 and defines how enriched playback event data published into enriched output stream 505 or stored in playback event data store 507 is structured. In some embodiments, the schema is distributed to data consumer systems 511 as well as event sessionizer 320 so that downstream systems can determine how to extract whatever data is relevant to the downstream system based on the schema.

At step 610, event publisher application 317 publishes the enriched playback event into enriched output stream 505 and stores the enriched playback event into the playback event data store 507. In one embodiment, the enriched output stream 505 is implemented using Apache Kafka Streams. The enriched playback event is generated according to a schema that defines a structured format for the enriched playback event. The schema is stored by or accessible to control server 120 and defines how enriched playback event data published into enriched output stream 505 or stored in playback event data store 507 is structured. In some embodiments, the schema is distributed to data consumer systems 511 as well as event sessionizer 320 so that downstream systems can determine how to extract whatever data is relevant to the downstream system based on the schema.

### Generating Sessions Based on Enriched Playback Events

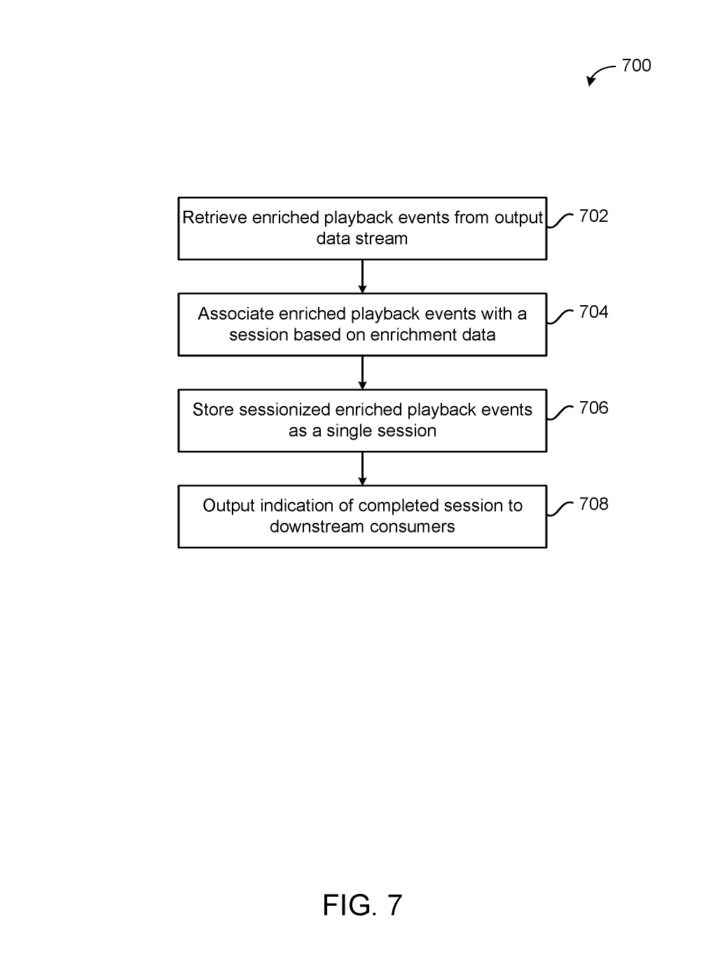

FIG. 7 is a flow diagram of method steps for generating session data from enriched playback event data published by the event publisher application 317. The enriched playback event data is generated in response to receiving playback events from an endpoint device 115 on a playback event stream 501 within a streaming media service. Although the method steps are described in conjunction with the systems of FIGS. 1-5, persons skilled in the art will understand that any system configured to perform the method steps, in any order, is within the scope of the present invention.

As shown, a method 700 begins at step 702, where event sessionizer 320 retrieves an enriched playback event from an enriched output stream 505. As noted above, the enriched playback event data is generated by event publisher application 317 based on playback event data reported by an endpoint device 115.

At step 704, event sessionizer 320 associates the enriched playback event data published by event publisher application 317 to a session on an endpoint device 115. In some embodiments, a session corresponds to providing a specific content item, such as an auxiliary content item, to a specific endpoint device 115. The session also corresponds to the playback events that are generated by the endpoint device 115 when the endpoint device 115 plays back the content item. For example, the session includes playback event data such as commencement of the auxiliary content item, quartile playback events, pause or seek events, playback completion events, or any other playback events associated with the content item that are referenced above.

Accordingly, the event sessionizer 320 identifies enriched events corresponding to a single session based on one or more identifiers or metadata embedded in the enriched events. For example, event sessionizer 320 correlates enriched events together based on an auxiliary content item impression identifier, which can be a unique token, or one among many unique tokens, that are provided to the endpoint device 115 along with the content item. The endpoint device 115 can provide the unique token back to the event publisher application 317 when reporting a playback event on the playback event stream 501. Accordingly, event publisher application 317 can include the unique token in the enriched playback event along with other metadata that the event sessionizer 320 can utilize to identify events that should be correlated together into a single session.

At step 706, event sessionizer 320 stores the sessionized enriched playback event data as a single session in the session data store 509. In one embodiment, event sessionizer 320 creates one or more data structures representing the session and stores the session data in the session data store 509. The session can include information about all of the enriched playback event data associated with the session.

At step 708, event sessionizer 320 outputs an indication of a completion session to one or more data consumer systems 511. As noted above, a data consumer system 511 is a downstream system that performs one or more operations on enriched playback event data from enriched output stream 505 or playback event data store 507. The event sessionizer 320 is an example of a type of data consumer system 511. Other examples include a system that tracks impressions for campaigns as well as frequency capping parameters that are created for a campaign. An auxiliary content item server can utilize such a system to ensure that ads are served within frequency capping limits that are specified for the campaign. Another example of a data consumer system 511 includes a system that calculates metrics based on the enriched playback event data from enriched output stream 505 or playback event data store 507. For example, real-time metrics can be calculated to assess delivery health of a campaign, apply budget capping functionality, calculate reach metrics, or determine any other performance or health related metrics associated with a campaign. As another example, a data consumer system 511 can also include a system that continuously or periodically sends information to third party systems, such as external systems, by extracting information from an enriched playback event structured according to the schema and reporting event data to the third-party system.

In sum, a playback event publisher receives playback event data from an endpoint device. The playback event data corresponds to playback of a content item, such as an auxiliary content item, on the endpoint device. The playback event data includes an identifier that is associated with a campaign linked to the content provided to the endpoint device. When a playback event is received from the endpoint device, the playback event publisher identifies the campaign associated with the content item.

The playback event publisher identifies metadata associated with the campaign based on the identifier and generates enriched playback event data based on the playback event received from the endpoint device and the metadata. The enriched playback event data is then published to an output data stream that is provided to downstream data consumers. The playback event publisher also stores the enriched playback event data into a data store so that downstream data consumers can access the metadata associated with the campaign as well as the playback event data from the output data stream or from the data store.

Additionally, an event sessionizer identifies sessions based on the enriched playback event data and saves session data associated with the enriched playback event data in a session data store. By generating coherent sessions from multiple playback event data, downstream data consumers can generate analytics based on the sessions generated by the event sessionizer.

At least one technical advantage of the disclosed techniques relative to the prior art is that the disclosed techniques enable a streaming service to obtain and distribute playback event data relating to playback of content in real time. In particular, the disclosed techniques provide a mechanism for reliably identifying sessions corresponding to playback of content based on playback event data received from an endpoint device. The identified sessions are output as a data stream in real time, thereby reducing or eliminating latency between when playback of the content occurs and when information about the session is made available to downstream consumers. By decoupling the ingestion of playback event data from subsequent session identification and distribution, the disclosed techniques further enable improved scalability, fault isolation, and throughput in environments where large volumes of playback events are generated. Such an approach can substantially improve overall system performance and reduce latency associated with tracking playback events in a streaming media service, particularly in streaming media services that serve large or highly concurrent user bases.

These technical advantages provide one or more technological advancements over prior art approaches.
1. In some embodiments, a computer-implemented method for processing playback event data comprises identifying a content item for playback by an endpoint device, wherein the content item is associated with a campaign and an identifier, transmitting the content item to the endpoint device for playback, receiving playback event data associated with playback of the content item by the endpoint device, extracting the identifier from the playback event data, retrieving metadata associated with the campaign from a metadata data store, enriching the playback event data with the metadata, and generating an output data stream that includes the playback event data.
2. The computer-implemented method of clause 1, wherein the playback event data is published in a data stream as a key-value record.
3. The computer-implemented method of clauses 1 or 2, wherein at least one of a key or a value of the key-value record is the identifier.
4. The computer-implemented method of any of clauses 1-3, wherein the identifier uniquely identifies playback of the content item by the endpoint device with the content item.
5. The computer-implemented method of any of clauses 1-4, wherein the playback event data comprises an event identifying that the content item is played back by the endpoint device, a pause event associated with the content item, an event identifying interaction with the content item, a quick-response (QR) code scan event, an impression event, or a seek event.
6. The computer-implemented method of any of clauses 1-5, wherein publishing the playback event data to the output data stream comprises formatting the playback event data according to a playback event schema.
7. The computer-implemented method of any of clauses 1-6, wherein enriching the playback event data with the metadata comprises storing the playback event data in a data store with the metadata associated with the campaign from the metadata data store.
8. The computer-implemented method of any of clauses 1-7, further comprising retrieving a plurality of playback events from the output data stream, determining that a subset of the playback events are associated with a single session on the endpoint device, generating a session data structure corresponding to the single session, and storing the session data structure in a data store.
9. The computer-implemented method of any of clauses 1-8, further comprising calculating a plurality of analytics based on the single session in the session data structure, the plurality of analytics associated with performance of the content item relative to other content items.
10. The computer-implemented method of any of clauses 1-9, wherein enriching the playback event data with the metadata comprises identifying the content item corresponding to the playback event data, and wherein the method further comprises retrieving the playback event data from the output data stream, identifying the content item corresponding to the playback event data, determining whether a frequency cap for the content item has been exceeded based on the playback event data, and updating a frequency cap metric based on the determination.
11. The computer-implemented method of any of clauses 1-10, further comprising storing the playback event data in a data store with a plurality of playback events.
12. The computer-implemented method of any of clauses 1-11, further comprising asynchronously computing at least one playback metric based on the plurality of playback events in the data store.
13. In some embodiments, one or more non-transitory computer-readable media include instructions that, when executed by one or more processors, cause the one or more processors to process playback event data by performing the steps of identifying a content item for playback by an endpoint device, wherein the content item is associated with a campaign and an identifier, transmitting the content item to the endpoint device for playback, receiving playback event data associated with playback of the content item by the endpoint device, extracting the identifier from the playback event data, retrieving metadata associated with the campaign from a metadata data store, enriching the playback event data with the metadata, and generating an output data stream that includes the playback event data.
14. The one or more non-transitory computer-readable media of clause 13, wherein the playback event data is received from a telemetry system associated with a streaming media service.
15. The one or more non-transitory computer-readable media of clauses 13 or 14, wherein the playback event data corresponds to an event identifying that the content item is played back by the endpoint device, a pause event associated with the content item, an event identifying interaction with the content item, a quick-response (QR) code scan event, an impression event, or a seek event.
16. The one or more non-transitory computer-readable media of any of clauses 13-15, wherein publishing the playback event data to the output data stream comprises formatting the playback event data according to a playback event schema.
17. The one or more non-transitory computer-readable media of any of clauses 13-16, wherein enriching the playback event data with the metadata comprises storing the playback event data in a data store with the metadata associated with the campaign from the metadata data store.
18. The one or more non-transitory computer-readable media of any of clauses 13-17, further comprising retrieving a plurality of playback events from the output data stream, determining that a subset of the playback events are associated with a single session on the endpoint device, generating a session data structure corresponding to the single session, and storing the session data structure in a data store.
19. The one or more non-transitory computer-readable media of any of clauses 13-18, further comprising calculating a plurality of analytics based on the single session in the session data structure, the plurality of analytics associated with performance of the content item relative to other content item.
20. In some embodiments, a system comprises one or more memories storing instructions, and one or more processors coupled to the one or more memories that, when executing the instructions, perform the steps of identifying a content item for playback by an endpoint device, wherein the content item is associated with a campaign and an identifier, transmitting the content item to the endpoint device for playback, receiving playback event data associated with playback of the content item by the endpoint device, extracting the identifier from the playback event data, retrieving metadata associated with the campaign from a metadata data store, enriching the playback event data with the metadata, and generating an output data stream that includes the playback event data.

Any and all combinations of any of the claim elements recited in any of the claims and/or any elements described in this application, in any fashion, fall within the contemplated scope of the present invention and protection.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module,” a “system,” or a “computer.” In addition, any hardware and/or software technique, process, function, component, engine, module, or system described in the present disclosure may be implemented as a circuit or set of circuits. Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. A computer-implemented method for processing playback event data, the method comprising:
identifying a content item for playback by an endpoint device, wherein the content item is associated with a campaign and an identifier;
transmitting the content item to the endpoint device for playback;
receiving playback event data associated with playback of the content item by the endpoint device;
extracting the identifier from the playback event data;
retrieving metadata associated with the campaign from a metadata data store;
enriching the playback event data with the metadata; and
generating an output data stream that includes the playback event data.

2. The computer-implemented method of claim 1, wherein the playback event data is published in a data stream as a key-value record.

3. The computer-implemented method of claim 2, wherein at least one of a key or a value of the key-value record is the identifier.

4. The computer-implemented method of claim 1, wherein the identifier uniquely identifies playback of the content item by the endpoint device with the content item.

5. The computer-implemented method of claim 1, wherein the playback event data comprises an event identifying that the content item is played back by the endpoint device, a pause event associated with the content item, an event identifying interaction with the content item, a quick-response (QR) code scan event, an impression event, or a seek event.

6. The computer-implemented method of claim 1, wherein publishing the playback event data to the output data stream comprises formatting the playback event data according to a playback event schema.

7. The computer-implemented method of claim 1, wherein enriching the playback event data with the metadata comprises storing the playback event data in a data store with the metadata associated with the campaign from the metadata data store.

8. The computer-implemented method of claim 1, further comprising:
retrieving a plurality of playback events from the output data stream;
determining that a subset of the playback events are associated with a single session on the endpoint device;
generating a session data structure corresponding to the single session; and
storing the session data structure in a data store.

9. The computer-implemented method of claim 8, further comprising calculating a plurality of analytics based on the single session in the session data structure, the plurality of analytics associated with performance of the content item relative to other content items.

10. The computer-implemented method of claim 1, wherein enriching the playback event data with the metadata comprises identifying the content item corresponding to the playback event data, and wherein the method further comprises:
retrieving the playback event data from the output data stream;
identifying the content item corresponding to the playback event data;
determining whether a frequency cap for the content item has been exceeded based on the playback event data; and
updating a frequency cap metric based on the determination.

11. The computer-implemented method of claim 1, further comprising storing the playback event data in a data store with a plurality of playback events.

12. The computer-implemented method of claim 11, further comprising asynchronously computing at least one playback metric based on the plurality of playback events in the data store.

13. One or more non-transitory computer-readable media including instructions that, when executed by one or more processors, cause the one or more processors to process playback event data by performing the steps of:
identifying a content item for playback by an endpoint device, wherein the content item is associated with a campaign and an identifier;
transmitting the content item to the endpoint device for playback;
receiving playback event data associated with playback of the content item by the endpoint device;
extracting the identifier from the playback event data;
retrieving metadata associated with the campaign from a metadata data store;
enriching the playback event data with the metadata; and
generating an output data stream that includes the playback event data.

14. The one or more non-transitory computer-readable media of claim 13, wherein the playback event data is received from a telemetry system associated with a streaming media service.

15. The one or more non-transitory computer-readable media of claim 13, wherein the playback event data corresponds to an event identifying that the content item is played back by the endpoint device, a pause event associated with the content item, an event identifying interaction with the content item, a quick-response (QR) code scan event, an impression event, or a seek event.

16. The one or more non-transitory computer-readable media of claim 13, wherein publishing the playback event data to the output data stream comprises formatting the playback event data according to a playback event schema.

17. The one or more non-transitory computer-readable media of claim 13, wherein enriching the playback event data with the metadata comprises storing the playback event data in a data store with the metadata associated with the campaign from the metadata data store.

18. The one or more non-transitory computer-readable media of claim 13, further comprising:
retrieving a plurality of playback events from the output data stream;
determining that a subset of the playback events are associated with a single session on the endpoint device;
generating a session data structure corresponding to the single session; and
storing the session data structure in a data store.

19. The one or more non-transitory computer-readable media of claim 18, further comprising calculating a plurality of analytics based on the single session in the session data structure, the plurality of analytics associated with performance of the content item relative to other content item.

20. A system comprising:
one or more memories storing instructions; and
one or more processors coupled to the one or more memories that, when executing the instructions, perform the steps of:
identifying a content item for playback by an endpoint device, wherein the content item is associated with a campaign and an identifier;
transmitting the content item to the endpoint device for playback;
receiving playback event data associated with playback of the content item by the endpoint device;
extracting the identifier from the playback event data;
retrieving metadata associated with the campaign from a metadata data store;
enriching the playback event data with the metadata; and
generating an output data stream that includes the playback event data.
